(19) United States
(12) Patent Application Publication
(10) Pub. No.: US 2020/0145208 A1
(43) Pub. Date: May 7, 2020

(54) METHOD AND DEVICE FOR ENCRYPTING AND DECRYPTING SOFTPHONE, AND COMPUTER-READABLE STORAGE MEDIUM

(71) Applicant: Ping An Technology (Shenzhen) Co., Ltd., Shenzhen, Guangdong (CN)

(72) Inventor: Zhoucheng Yi, Shenzhen, Guangdong (CN)

(21) Appl. No.: 16/307,946

(22) PCT Filed: Feb. 5, 2018
(86) PCT No.: PCT/CN2018/075202

§ 371 Date: Dec. 7, 2018

(30) Foreign Application Priority Data
Oct. 9, 2017 (CN) 201710933040.5

(51) Int. Cl. H04L 9/08; H04L 9/32; H04L 29/06; H04M 3/51; H04M 7/00; H04W 12/02; H04M 15/00

(52) U.S. Cl. CPC H04L 9/0869; H04L 9/3297; H04L 63/0272; H04M 15/755; H04M 7/0078; H04W 12/02; H04M 3/51

(57) ABSTRACT

Disclosed are a method and a device for encrypting and decrypting softphone, as well as a computer-readable storage medium. The method for encrypting and decrypting softphone includes: in response to a softphone call instruction, obtaining a phone number corresponding to the call instruction, and encrypting the phone number to generate a cipher text phone number; sending the cipher text phone number to the phone-platform server for the phone-platform server to return the cipher text phone number to the local-system server through a private network; decrypting the cipher text phone number to obtain a plaintext phone number at local-system server, and sending the plaintext phone number to the phone-platform server through the private network.

### CROSS-REFERENCE TO RELATED APPLICATIONS

The present application claims the benefit of China Patent Application No. 201710933040.5, filed on Oct. 9, 2017 before the State Intellectual Property Office and entitled “Method and Device for Encrypting and Decrypting Softphone, and Computer-readable Storage Medium”, the entirety of which is hereby incorporated herein by reference.

### TECHNICAL FIELD

The present disclosure relates to the field of network communication technology, and more particularly relates to a method and a device for encrypting and decrypting softphone, as well as a computer-readable storage medium.

### BACKGROUND

A softphone is also called an IP phone, which can transmit voice by the Internet Protocol. As long as you are on the same network, you can make calls without restrictions. And it can support multiple call modes, such as PC to PC, PC to phone, and phone to PC, etc. At present, many customer service representatives of service system use soft phones, and when customer service representatives are making a phone call, they get the encrypted phone number stored in the local system server and send the encrypted phone number to a phone-platform server through public network with corresponding secret key, for the phone-platform server to make a phone call after decrypting the encrypted phone number. There is a risk of being intercepted when encrypted phone numbers and keys are sent over the public network; and at the other hand, the telephone platform server may have a leaking risk when decrypting the encrypted phone number, and the personal information of the customer may be leaked.

### SUMMARY

It is therefore one main object of the present disclosure to provide a method and a device for encrypting and decrypting softphone as well as a computer-readable storage medium, aiming to solve the technical problem in the prior art that the encrypted phone number leaked and lead to leakage of personal information.

To achieve the above object, this disclosure provides a method for encrypting and decrypting softphone, the method including the following operations. In response to a softphone call instruction, obtaining a phone number corresponding to the call instruction, and encrypting the phone number to generate a cipher text phone number; sending the cipher text phone number to the phone-platform server for the phone-platform server to return the cipher text phone number to the local-system server through the private network; decrypting the cipher text phone number to obtain a plaintext phone number at local-system server, and sending the plaintext phone number to the phone-platform server through the private network.

In some embodiments, the block of sending the cipher text phone number to the phone-platform server for the phone-platform server to return the cipher text phone number to the local-system server through the private network includes the following operations. Sending the cipher text phone number to the front end of the local system, to receive comment information added from the front end of the local system, and send the cipher text phone number to the phone-platform server from the front end of the local system. Receiving the cipher text phone number returned by the phone platform server through the private network.

In some embodiments, the block of obtaining a phone number corresponding to the call instruction and encrypting the phone number to generate a cipher text phone number includes the following operations. Generating a random number according to the following formula: Xₙ₊₁=(aXₙ+b)mod c, wherein the Xₙ₊₁ is the n+1th random number and the Xₙ is the nth random number, a, b, c are constants and are prime numbers. Encrypting the obtained phone number with the random number according to a preset operation rule to obtain an encrypted intermediate result. Obtaining the first clock information that receives the call instruction, and adding the first clock information to the encrypted intermediate result to generate a cipher text phone number.

In some embodiments, the block of decrypting the cipher text phone number at the local system server to obtain a plain text phone number includes the following operations. When receiving the cipher text phone number returned by the phone-platform server, acquiring the second clock information that receives the cipher text phone number and the first clock information included in the cipher text phone number. When the first clock information and the second clock information match, decrypting the cipher text phone number to obtain a plain text phone number according to the random number.

In some embodiments, the block of decrypting the cipher text phone number to obtain a plain text phone number according to the random number includes the following operations. Determining whether a difference between the time value of the second clock information and the time value of the first clock information is within a preset time range. When the difference between a time value of the second clock information and a time value of the first clock information is within a preset time range, determining the first clock information and the second clock information match. When the first clock information and the second clock information match, the cipher text telephone number and the random number are inversely operated by a preset operation rule to decrypt the cipher text telephone number to obtain a plain text telephone number.

In some embodiments, the method further includes the opinion subsequent to the block of sending the plaintext phone number to the phone platform server through a private network: transmitting the preset encryption scheme in the local system server to the telephone platform server through the private network, so that the telephone platform server encrypts the call recording corresponding to the plain text telephone number according to the preset encryption scheme.

In some embodiments, the method further includes the opinion subsequent to the block of the telephone platform server encrypts the call recording corresponding to the plain text telephone number according to the preset encryption scheme: Receiving encrypted call recordings transmitted by the telephony platform server through a private network. Adding a tag to the encrypted call recording, storing it, and sending the tag to the local system front end.

In some embodiments, the method further includes the opinion subsequent to the block of storing the encrypted call content: receiving a query instruction sent by the front end of the local system, and acquiring an encrypted call recording corresponding to the query instruction, as well as a decryption scheme corresponding to the preset encryption scheme. Transmitting the encrypted call recording and decryption scheme to a local system front end for the local system front end to decrypt the encrypted call recording through a decryption scheme.

In addition, in order to achieve the above object, the present disclosure further provides a device for encrypting and decrypting softphone, the device including a memory, a processor, a communication bus, and a softphone encrypting and decrypting program stored in the memory. The communication bus is configured to facilitate a communication connection between the processor and the memory. The processor is configured to execute the softphone encrypting and decrypting program to perform the following operations: In response to a softphone call instruction, obtaining a phone number corresponding to the call instruction, and encrypting the phone number to generate a cipher text phone number; sending the cipher text phone number to the phone-platform server for the phone-platform server to return the cipher text phone number to the local-system server through the private network; decrypting the cipher text phone number to obtain a plaintext phone number at local-system server, and sending the plaintext phone number to the phone-platform server through the private network.

Further, in order to achieve the foregoing object, the present disclosure further provides a computer-readable storage medium that stores one or more programs, which can be executed by one or more processors to perform the following operations: In response to a softphone call instruction, obtaining a phone number corresponding to the call instruction, and encrypting the phone number to generate a cipher text phone number; sending the cipher text phone number to the phone-platform server for the phone-platform server to return the cipher text phone number to the local-system server through the private network; decrypting the cipher text phone number to obtain a plaintext phone number at local-system server, and sending the plaintext phone number to the phone-platform server through the private network.

According to this embodiment of softphone encryption and decryption method, device and computer readable storage medium, when receiving the softphone call instruction, the phone number corresponding to the call instruction is obtained for encryption, and the cipher text phone number is generated. Sending the generated cipher text telephone number to the telephone platform server, the telephone platform server returns the cipher text telephone number to the local system server through the private network, and decrypts the cipher text telephone number according to the encryption scheme at the local system server according to the encryption scheme, and sending the decrypted plaintext phone number to the phone platform server over a private network. The method of encrypting and decrypting softphone telephone number is performed on the local system server, cause the local system server has a good decryption security, the key does not need to be sent to the telephone platform server, the interception is avoided during the transmission process, and the decrypted plaintext telephone number is sent to the telephone platform server through the private network to further avoid the risk of compromise and ensure the security of the customer's personal information.

### BRIEF DESCRIPTION OF THE ACCOMPANYING DRAWINGS

FIG. 1 is an illustrative flowchart of a first embodiment of a method for encrypting and decrypting softphone in accordance with this disclosure.

FIG. 2 is an illustrative flowchart of a second embodiment of a method for encrypting and decrypting softphone in accordance with this disclosure.

FIG. 3 is an illustrative flowchart of a third embodiment of a method for encrypting and decrypting softphone in accordance with this disclosure.

FIG. 4 is a schematic diagram of a device in terms of hard operating environment involved in the method embodiments in accordance with this disclosure.

Various implementations, functional features, and advantages of this disclosure will now be described in further detail in connection with some illustrative embodiments and the accompanying drawings.

### DETAILED DESCRIPTION OF ILLUSTRATIVE EMBODIMENTS

It will be appreciated that the specific embodiments described herein are merely illustrative of the disclosure and are not intended to limit the disclosure.

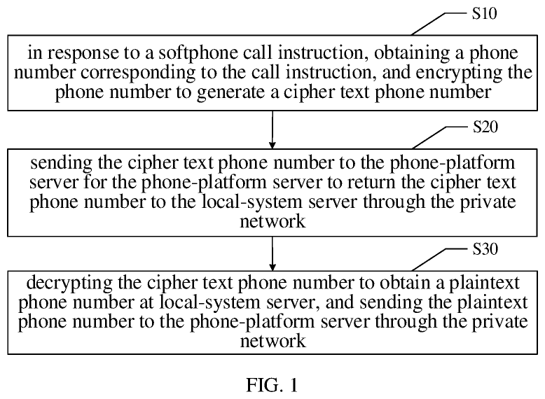

This disclosure provides a method for encrypting and decrypting softphone. As illustrated in FIG. 1, in a first embodiment of the method for encrypting and decrypting softphone in accordance with the present disclosure, the method includes the following blocks S10 to S30.

In S10, in response to a softphone call instruction, obtaining a phone number corresponding to the call instruction, and encrypting the phone number to generate a cipher text phone number.

The softphone encryption and decryption method of the embodiment is suitable for the customer service representatives to encrypt and decrypt the customer's phone number when contacting the customer through the soft phone to ensure the security of the customer's personal information. The local system is installed with a dialing software for making soft calls. When the customer service representative has a need to make a soft call, enter the customer corresponding information in the application interface of the dialing software to make a call. The customer correspondence information may be a customer code, and each customer corresponds to a unique customer code. The customer code is used to dial the customer's phone number, and the application interface of the software is prevented from directly displaying the customer's phone number, thereby avoiding leakage of customer information. The customer code input by the application interface is used as a call instruction for calling the softphone. When receiving the softphone call instruction, the phone number corresponding to the call instruction is obtained, and encrypt the phone number to generate a cipher text phone number. Since each customer corresponds to a unique code, the phone number of the customer can be obtained through the code of the call instruction. When the phone number is known, the phone number is encrypted in real time. The real-time encryption is performed after receiving the call instruction, so that the generated cipher text telephone number can be securely secured, and each telephone number can be encrypted in advance, and directly called when the call instruction is received. The block of obtaining the phone number corresponding to the calling instruction and encrypting the phone number to generate the cipher text phone number includes the following block S11 to S13.

In S11, generating a random number according to the following formula: Xₙ₊₁≤(aXₙ+b)mod c, wherein the Xₙ₊₁ is the n+1th random number and the Xₙ random number, a, b, c are constants and are prime numbers.

After obtaining the phone number corresponding to the calling instruction, generating a random number to calculate the random number and the obtained phone number, and encrypt the phone number. The random number can be generated by the random number generator or generated according to the random number generation formula. When generated by the random number generation formula, the generation formula is as shown in (1):

X₊₁=(aXₙ+b)modc (1);

Where Xₙ₊₁ is the n+1th random number, Xₙ is the nth random number, and a, b, and c are constants and are prime numbers. For example, a, b, and c are 5, 11, and 7 respectively; the nth random number is 7, and the n+1th random number is 4. Exceptionally, when the random number is generated for the first time, i.e. n=0, the default value of the 0th random number is set, such as 3, so that the first random number=(5*3+11) mod 7=5. After generating a random number according to a random number generation formula, the random number can be used to encrypt the phone number according to a preset operation rule.

In S12, encrypting the obtained phone number with the random number according to a preset operation rule to obtain an encrypted intermediate result.

After generating a random number, the random number can be used to encrypt the phone number according to a preset operation rule. The preset operation rule may be an arithmetic operation rule such as addition, subtraction, multiplication, division, multiplication and square root, or may be a logical operation rule such as AND, OR, NAND, XOR, etc., and may be set according to user requirements. Generate a cipher text phone number according to the operation method by using the random number and phone number. If the random number is 4 and the telephone number is 15069824153, and the operation is XOR, the random number and the telephone number are converted into the secondary system, i.e. 100 and 1110000010001110110100010010011001. When a XOR operation is performed, for the insufficient bits of the value. The left side of the value is padded with 0, as shown in the following table:

| | | | | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|---|---|---|
| Random | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 1 | 0 | 0 |
| number | | | | | | | | | | | | | | | | | | | | | | | | | | | | | | | | | | |
| Phone | 1 | 1 | 1 | 0 | 0 | 0 | 0 | 0 | 1 | 0 | 0 | 0 | 1 | 1 | 1 | 0 | 1 | 1 | 0 | 1 | 0 | 0 | 0 | 1 | 0 | 0 | 1 | 0 | 0 | 1 | 1 | 0 | 0 | 1 |
| number | | | | | | | | | | | | | | | | | | | | | | | | | | | | | | | | | | |
| Operation | 1 | 1 | 1 | 0 | 0 | 0 | 0 | 0 | 1 | 0 | 0 | 0 | 1 | 1 | 1 | 0 | 1 | 1 | 0 | 1 | 0 | 0 | 0 | 1 | 0 | 0 | 1 | 0 | 0 | 1 | 1 | 1 | 0 | 1 |
| result | | | | | | | | | | | | | | | | | | | | | | | | | | | | | | | | | | |

Convert the result of the operation to decimal to get 15069824157, which is the intermediate result of encryption. In addition, considering that the number of digits of the telephone number is very long, generally 11 digits, the telephone number can be divided into several segments and encrypted separately, for example, divided it into three segments, the first segment is the first three digits, the second segment is the middle four digits, and the third paragraph is the last four. The first segment, the second segment, and the third segment are respectively encrypted according to a preset operation rule by using a random number, and three operation results are obtained, so that the data is better encrypted, and the three operation results are integrated to form an encrypted intermediate result.

In S13, obtaining the first clock information that receives the call instruction, and adding the first clock information to the encrypted intermediate result to generate a cipher text phone number.

In order to further improve the encryption of data, time can be reflected in the encrypted data. Obtaining the first clock information of the time when received call instruction, and adding the first clock information to the encrypted intermediate result obtained by the operation, as the start data of the intermediate result of the encryption, or the end data, or even added to the middle of the encrypted intermediate result, generate a cipher text phone number. If the first clock information is 8:16, then 0816 is used as the initial data of the encryption intermediate result to form the cipher text telephone number 081615069824157, or used as the ending data of the encryption intermediate result to form the cipher text telephone number 150698241570816, or added to the third digit of the encrypted intermediate result to forms the cipher text telephone number 1508160698241570816. Generating a cipher text phone number based on the generated random number and the received first clock information of the call instruction. For the same phone number, the generated password number is different because the random number generated each time and the received first clock information are different, so that the phone number has a good confidentiality. The method then continues to block S20.

In S20, sending the cipher text phone number to the phone platform server for the phone platform server to return the cipher text phone number to the local system server through the private network.

Further, after the cipher text phone number is generated, only the cipher text phone number is sent to the phone platform server, and the decrypted key as well as the encryption scheme are not sent to the phone platform server. Only when the mobile phone, the telephone, etc. connecting to the telephone platform server, they can make calls through the connection response of the telephone platform server. Because the phone platform server does not have a key and encryption scheme, the received cipher text phone number cannot be decrypted. It returns the received cipher text phone number to the local system server through the private network, and the local system server decrypts the cipher text phone number. The private network is a local area network that sets the local system server and the telephone platform server in the same area to ensure the security of communication. Specifically, the block of transmitting the cipher text telephone number to the telephone platform server for the telephone platform server to return the cipher text telephone number to the local system server through the private network includes the following block S21 to S22.

In S21, sending the cipher text phone number to the front end of the local system, receiving the remark information added by the front end of the local system, and transmitting the cipher text phone number to the phone platform server through the front end of the local system.

In S22, receiving the cipher text phone number returned by the phone platform server through the private network.

After the generating of the cipher text phone number, the phone platform server send the cipher text phone number to the front end of the local system, for displaying on the front end display interface. And some of the data is displayed in a hidden way as *, such as 155****6676, to prevent cipher text phone numbers from leaking. In addition, there is a remark item in the front-end display interface, and the customer service representative can add corresponding remark information to the cipher text phone number. The remark information can be the consultation information of the customer corresponding to the cipher text telephone number, the follow-up visit time, etc. Better serve customers by adding corresponding remarks. After receiving the remark information added by the customer service representatives at the front end of the local system, the local system front end sends the cipher text phone number to the phone platform server, so that the telephone platform server establishes a communication connection between the customer service representatives and the customer corresponding to the phone number when dialing the phone number. After receiving the cipher text phone number, the phone platform server returns the cipher text phone number to the local system server through the private network for the local system server to decrypt the cipher text phone number after receiving the returned cipher text phone number through the private network. The method then continues to block S30.

In S30, decrypting the cipher text phone number at the local system server to obtain a plain text phone number, and transmitting the plaintext phone number to the phone platform server through a private network.

Further, after receiving the cipher text telephone number returned by the telephone platform server through the private network, the local system server decrypts according to the decryption scheme corresponding to the encryption scheme when receiving the softphone call instruction, and obtains the plaintext telephone number. And sending the decrypted plaintext phone number to the phone platform server through a private network for making a call by the phone platform server. The step of decrypting the cipher text telephone number by the local system server to obtain a clear text telephone number includes the following block S31 to S32.

In S31, when receiving the cipher text phone number returned by the phone platform server, acquiring second clock information that receives the cipher text phone number and first clock information included in the cipher text phone number.

In S32, when the first clock information and the second clock information match, the cipher text phone number is decrypted according to the random number to obtain a clear text phone number.

When the local system server receives the cipher text phone number returned by the phone platform server, obtains the time of receiving the cipher text phone number, and uses this time as the second clock information. Simultaneously obtaining the first clock information included in the received cipher text telephone number, because the first clock information may be located at the beginning data of the cipher text telephone number, or may be the end data of the cipher text telephone number, or the intermediate data of the cipher text telephone number. Therefore, the location of the first clock information needs to be determined according to an agreement between the local system server and the phone platform server, so that the first clock information is obtained according to the location of the first clock information. Matching the obtained first clock information and the second clock information, and decrypting the cipher text phone number according to the random number to obtain a plain text phone number when the matching is successful. Specifically, when the first clock information and the second clock information match, the step of decrypting the cipher text phone number according to the random number to obtain the plaintext phone number includes the following block S321 to S323.

In S321, determining whether a difference between a time value of the second clock information and a time value of the first clock information is within a preset time range.

In S322, when the difference between the time value of the second clock information and the time value of the first clock information is within a preset time range, determining that the first clock information and the second clock information match.

In S323, when the first clock information and the second clock information match, the cipher text telephone number and the random number are inversely operated by a preset operation rule to decrypt the cipher text telephone number to obtain a plain text telephone number.

Specifically, the solution is preset with a preset time range for determining whether the difference between the second clock information of the received cipher text telephone number and the first clock information of the received call instruction is short enough. When the difference between the time value of the second clock information and the time value of the first clock information is within a preset time range, it indicates that the time interval between receiving the cipher text telephone number and receiving the call instruction is sufficiently short, and determining the first the clock information is matched with the second clock information, and the cipher text phone number is decrypted according to the random number. When decrypting, the cipher text telephone number and the random number are inversely operated corresponding to the preset operation rule, and the inverse operation is an operation for decrypting the cipher text telephone number into the plaintext telephone number. If the operation used for encryption is addition, the inverse operation is subtraction; if the operation used for encryption is division, the inverse operation is multiplication; or if the operation used for encryption is XOR, then the inverse operation is XOR again. The local system server performs an inverse operation of the preset operation rule according to the random number, and decrypts the cipher text phone number into the plaintext phone number. Sending the plain text phone number to the phone platform server through the private network, the phone platform server makes a call to the phone number, and establishes a communication connection with the customer service representatives of the local system front end.

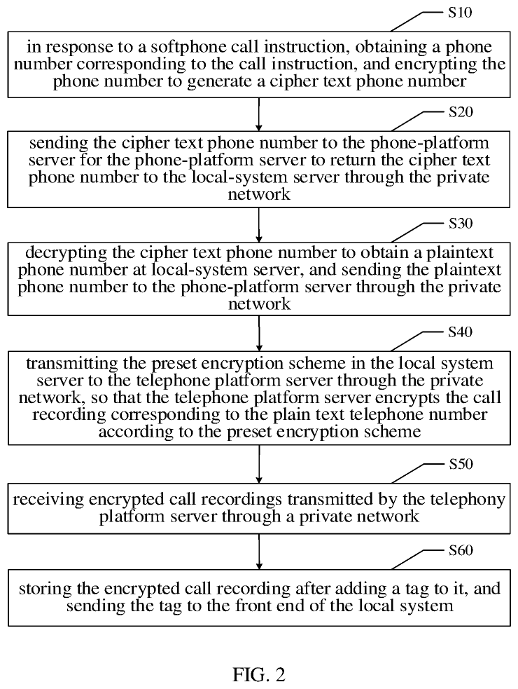

Further, as illustrated in FIG. 2, a second embodiment of the method for encrypting and decrypting softphone is provided herein on the basis of the first embodiment of the method for encrypting and decrypting softphone according to this disclosure. In the second embodiment, after the block of sending the plain text phone number to the phone platform server over a private network, the method further includes the following block S40 to S60.

In S40, the preset encryption scheme in the local system server is transmitted to the telephone platform server through the private network, so that the telephone platform server encrypts the call recording corresponding to the plain text telephone number according to the preset encryption scheme.

Further, after the decrypted plaintext phone number is sent to the phone platform server, the phone platform server calls the phone number. And after the call is connected, establishing the call connection between the customer corresponding to the telephone number and the customer service representative corresponding to the front end of the local system, and the call between the two is recorded. In order to ensure the confidentiality of the recording, a mechanism for encrypting the call recording is set, wherein the encryption scheme is transmitted by the local system server. The local system server is preset with a preset encryption scheme, and the preset encryption scheme is transmitted to the telephone platform server through a dedicated network, and the telephone platform server encrypts the call recording corresponding to the plaintext telephone number according to the preset encryption scheme. Specifically, the preset encryption scheme may encrypt the call recording by selecting several numbers of the phone numbers, or encrypt the call recording by using the unique code of the customer. After the call corresponding to the plain text phone number ends, and generated the complete call recording, the call recording is encrypted according to the received preset encryption scheme. And after the block of encrypting the call recording, the method further include the following block S50 to S60.

In S50, receiving encrypted call recordings transmitted by the telephony platform server through a private network.

In S60, adding a tag to the encrypted call recording and storing it, and sending the tag to the local system front end.

Further, after the phone platform server encrypts the call recording, the encrypted call recording is sent to the local system server through the private network. After receiving the encrypted call recording, the local system server stores the encrypted call recording. And when storing, the encrypted call recording can be tagged, the tag can be a client code, or can be encoded according to the stored encrypted call recording sequence. And send this tag to the local system front-end for displaying or automatically added to the customer note information corresponding to the phone number for easy access.

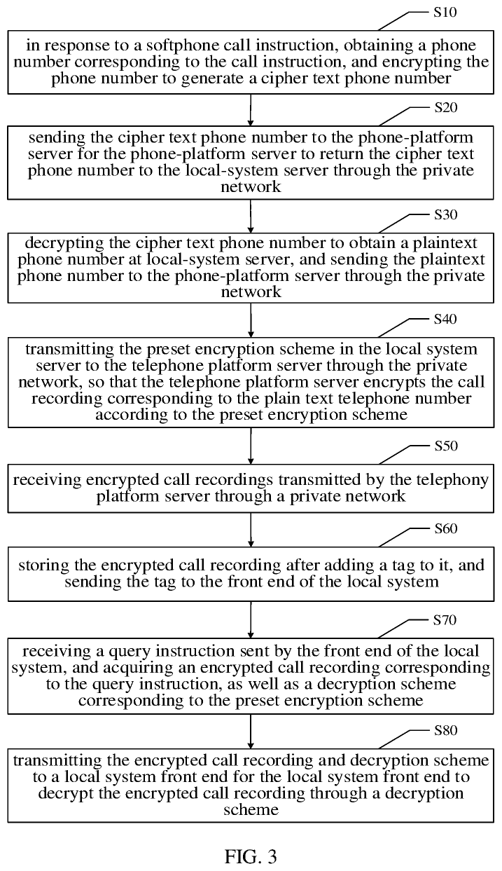

Further, as illustrated in FIG. 3, a third embodiment of the method for encrypting and decrypting softphone is provided herein on the basis of the second embodiment of the method for encrypting and decrypting softphone according to this disclosure. In the third embodiment, after the block of storing the encrypted call recording, the method further includes the following block S70 to S80.

In S70, receiving a query instruction sent from the front end of the local system, and acquiring an encrypted call recording corresponding to the query instruction and a decryption scheme corresponding to the preset encryption scheme.

In S80, transmitting the encrypted call recording and decryption scheme to the front end of the local system for the local system front end to decrypt the encrypted call recording through a decryption scheme.

Specifically, when the customer or the customer service representative has the requirement for inquiring the call recording, the query instruction is sent to the front end of the local system, and the query instruction may be the corresponding tag in the remark information. When the customer requests the manual customer service to query the call recording, the manual customer service inputs the customer name in the front end of the local system, obtains the tag in the remark information corresponding to the customer name, and sends the tag as a query instruction to the local system server. After receiving the tag as the query instruction, the encrypted call recording and the decryption scheme corresponding to the preset encryption scheme are obtained according to the tag. After receiving the tag as the query instruction, the encrypted call recording and the decryption scheme corresponding to the preset encryption scheme are obtained according to the tag. The encrypted call recording and decryption scheme is transmitted to the front end of the local system, and the front end of the local system decrypts the encrypted call recording according to the decryption scheme, and provides the decrypted call recording to the customer to meet the query requirement of the customer.

It is noteworthy that those of ordinary skill in the art will able to understand all or part of the flows implementing the above embodiments of the disclosure can be accomplished by hardware or computer programs by controlling the relevant hardware. The computer program may be stored in a computer readable storage medium, and the storage medium mentioned above may be a read only memory, a magnetic disk or an optical disk, etc.

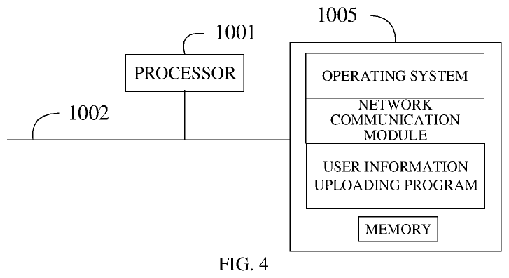

FIG. 4 is a schematic diagram of a device in terms of hard operating environment involved in the method embodiments in accordance with this disclosure.

The device for encrypting and decrypting softphone according to this embodiment of the present disclosure may be a personal computer (PC), or a terminal device such as a smart phone, a tablet computer, an e-book reader, a MP3 (Moving Picture Experts Group Audio Layer III) player, a MP4 (Moving Picture Experts Group Audio Layer IV) player, a portable computer, and so on.

As illustrated in FIG. 4, the device for encrypting and decrypting softphone may include a processor 1001 such as a CPU, a memory 1005, and a communication bus 1002. The communication bus 1002 is configured to facilitate connection and communication between the processor 1001 and the memory 1005. The memory 1005 may be a high-speed RAM memory, or a non-volatile memory such as a disk memory. The memory 1005 optionally may also be a storage device that is separate from the processor 1001 described above.

Optionally, the device for encrypting and decrypting softphone may further include a user interface, a network interface, a camera, an RF (Radio Frequency) circuitry, a sensor, an audio circuitry, a Wi-Fi module, and the like. The user interface may include a display, an input unit such as a keyboard, and an optional user interface may also include a standard wired interface and wireless interface. The network interface may optionally include a standard wired interface, and a wireless interface (such as a Wi-Fi interface).

Those skilled in the art can understand that the structure of the device of encrypting and decrypting softphone illustrated in FIG. 4 does not constitute a limitation on the user information uploading device. Thus, the user information uploading device may include more or less components than those illustrated, or some components may be combined, or different arrangements of components may be employed.

As illustrated in FIG. 4, the memory 1005 as a computer storage medium may include an operating system, a network communication module, and a softphone encrypting and decrypting program. The operating system is a program that manages and controls the hardware and software resources of the softphone encrypting and decrypting device, and supports the operation of the softphone encrypting and decrypting program and other software and/or programs. The network communication module is configured to facilitate the communication between various components within the memory 1005, and with other hardware and software in the device for encrypting and decrypting program.

In the device for encrypting and decrypting softphone as illustrated in FIG. 4, the processor 1001 is configured to execute the softphone encrypting and decrypting program stored in the memory 1005 to perform the blocks in above embodiments of the softphone encrypting and decrypting method.

The present disclosure provides a computer-readable storage medium storing one or more programs which can be executed by one or more processors to perform the steps of the above-described method for encrypting and decrypting softphone.

Also need to explain that as used herein, the terms “including,” “comprising,” or any other variants thereof are intended to encompass a non-exclusive inclusion, so that processes, methods, articles, or systems that include a series of elements will include not only those elements, but also other elements as well that haven't been explicitly listed or those elements inherent in such processes, methods, articles, or systems. In the absence of further restrictions, the element defined by the phrase “including/comprising a . . .” will not preclude the existence of additional such elements in the processes, methods, articles, or systems that include the element.

The above numbering of embodiments is intended for illustrative purposes only, and is not indicative of the pros and cons of these embodiments.

By the above description of embodiments, it will be evident to those of skill art that the methods according to the above embodiments can be implemented by means of software plus the necessary general-purpose hardware platform; they can of course be implemented by hardware, but in many cases the former will be more advantageous. Based on such an understanding, the essential technical solution of the disclosure, or the portion that contributes to the prior art may be embodied as software products. Computer software products can be stored in a storage medium (e.g., a ROM/RAM, a magnetic disk, an optical disk) and may include multiple instructions that, when executed, can cause a computing device (e.g., a mobile phone, a computer, a server, a network device, etc.), to execute the methods as described in the various embodiments of the disclosure.

The foregoing description merely portrays some illustrative embodiments according to the disclosure and therefore is not intended to limit the patentable scope of the disclosure. Any equivalent structural or flow transformations that are made taking advantage of the specification and accompanying drawings of the disclosure and any direct or indirect applications thereof in other related technical fields shall all fall in the scope of protection of the disclosure.

1. A method for encrypting and decrypting softphone, comprising:
in response to a softphone call instruction, obtaining a phone number corresponding to the call instruction, and encrypting the phone number to generate a cipher text phone number;
sending the cipher text phone number to the phone-platform server for the phone-platform server to return the cipher text phone number to the local-system server through a private network; and
decrypting the cipher text phone number to obtain a plaintext phone number at local-system server, and sending the plaintext phone number to the phone-platform server through the private network.

2. The method of claim 1, wherein the block of sending the cipher text phone number to the phone-platform server for the phone-platform server to return the cipher text phone number to the local-system server through a private network comprises:
sending the cipher text phone number to the front end of the local system, to receive comment information added from the front end of the local system, and send the cipher text phone number to the phone-platform server from the front end of the local system; and
receiving the cipher text phone number returned by the phone platform server through the private network.

3. The method of claim 1, wherein the block of obtaining a phone number corresponding to the call instruction, and encrypting the phone number to generate a cipher text phone number comprises:
generating a random number according to the following formula: Xₙ₊₁=(aXₙ+b)modc, wherein the Xₙ₊₁ is the n+1th random number and the Xₙ is the nth random number, a, b, and c are constants and are prime numbers; and
encrypting the obtained phone number using the random number according to a preset operational rule to obtain an encrypted intermediate result; and
obtaining the first clock information that receives the call instruction, and adding the first clock information to the encrypted intermediate result to generate a cipher text phone number.

4. The method of claim 3, wherein the block of decrypting the cipher text phone number to obtain a plaintext phone number at local-system server comprises:
when receiving the cipher text phone number returned by the phone-platform server, acquiring the second clock information that receives the cipher text phone number and the first clock information comprised in the cipher text phone number; and
when the first clock information matches the second clock information, decrypting the cipher text phone number to obtain the plain text phone number according to the random number.

5. The method of claim 4, wherein the block of when the first clock information matches the second clock information, decrypting the cipher text phone number to obtain the plain text phone number according to the random number comprises:
determining whether a difference between a time value of the second clock information and a time value of the first clock information is within a preset time range; and
when the difference between the time value of the second clock information and the time value of the first clock information is within a preset time range, determining that the first clock information matches the second clock information; and
when the first clock information matches the second clock information, the cipher text telephone number and the random number are inversely operated using the preset operational rule to decrypt the cipher text telephone number to obtain the plain text telephone number.

6. The method of claim 1, further comprising, subsequent to the block of sending the plaintext phone number to the phone-platform server through the private network:
transmitting the preset encryption scheme in the local system server to the telephone platform server through the private network, so that the telephone platform server encrypts the call recording corresponding to the plain text telephone number according to the preset encryption scheme.

7. The method of claim 6, further comprising, subsequent to the telephone platform server encrypting the call recording corresponding to the plain text telephone number according to the preset encryption scheme:
receiving encrypted call recording transmitted by the telephony platform server through the private network; and
storing the encrypted call recording after adding a tag to it, and sending the tag to the front end of the local system.

8. The method of claim 7, further comprising, subsequent to storing the encrypted call recording after adding a tag to it:
receiving a query instruction sent by the front end of the local system, and acquiring an encrypted call recording corresponding to the query instruction, as well as a decryption scheme corresponding to the preset encryption scheme; and
transmitting the encrypted call recording and decryption scheme to the front end of the local system to decrypt the encrypted call recording through a decryption scheme.

9. A device for encrypting and decrypting softphone, the device comprising a memory, a processor, a communication bus, and a softphone encrypting and decrypting program stored in the memory;
the communication bus being configured to communication connect the processor and the memory;
the processor being configured to execute the softphone encrypting and decrypting program to perform the following operations:
in response to a softphone call instruction, obtaining a phone number corresponding to the call instruction, and encrypting the phone number to generate a cipher text phone number;
sending the cipher text phone number to the phone-platform server for the phone-platform server to return the cipher text phone number to the local-system server through a private network; and
decrypting the cipher text phone number to obtain a plaintext phone number at local-system server, and sending the plaintext phone number to the phone-platform server through the private network.

10. The device of claim 9, wherein the block of sending the cipher text phone number to the phone-platform server for the phone-platform server to return the cipher text phone number to the local-system server through a private network comprises:
sending the cipher text phone number to the front end of the local system, to receive comment information added from the front end of the local system, and send the cipher text phone number to the phone-platform server from the front end of the local system; and
receiving the cipher text phone number returned by the phone platform server through the private network.

11. The device of claim 9, wherein the block of obtaining a phone number corresponding to the call instruction, and encrypting the phone number to generate a cipher text phone number comprises:
generating a random number according to the following formula: wherein the is the n+1th random number and the is the nth random number, a, b, and c are constants and are prime numbers; and
encrypting the obtained phone number using the random number according to a preset operational rule to obtain an encrypted intermediate result; and
obtaining the first clock information that receives the call instruction, and adding the first clock information to the encrypted intermediate result to generate a cipher text phone number.

12. The device of claim 11, wherein the block of decrypting the cipher text phone number to obtain a plaintext phone number at local-system server comprises:
when receiving the cipher text phone number returned by the phone-platform server, acquiring the second clock information that receives the cipher text phone number and the first clock information comprised in the cipher text phone number; and
when the first clock information matches the second clock information , decrypting the cipher text phone number to obtain the plain text phone number according to the random number.

13. The device of claim 12, wherein the block of when the first clock information matches the second clock information, decrypting the cipher text phone number to obtain the plain text phone number according to the random number comprises:
determining whether a difference between a time value of the second clock information and a time value of the first clock information is within a preset time range; and
when the difference between the time value of the second clock information and the time value of the first clock information is within a preset time range, determining that the first clock information matches the second clock information; and
when the first clock information matches the second clock information, the cipher text telephone number and the random number are inversely operated using the preset operational rule to decrypt the cipher text telephone number to obtain the plain text telephone number.

14. The device of claim 9, further comprising, subsequent to the block of sending the plaintext phone number to the phone-platform server through the private network:
transmitting the preset encryption scheme in the local system server to the telephone platform server through the private network, so that the telephone platform server encrypts the call recording corresponding to the plain text telephone number according to the preset encryption scheme.

15. A computer-readable storage medium storing a softphone encrypting and decrypting program, which when executed by a processor performs the following operations:
in response to a softphone call instruction, obtaining a phone number corresponding to the call instruction, and encrypting the phone number to generate a cipher text phone number;
sending the cipher text phone number to the phone-platform server for the phone-platform server to return the cipher text phone number to the local-system server through a private network; and
decrypting the cipher text phone number to obtain a plaintext phone number at local-system server, and sending the plaintext phone number to the phone-platform server through the private network.

16. The computer-readable storage medium of claim 15, wherein the block of sending the cipher text phone number to the phone-platform server for the phone-platform server to return the cipher text phone number to the local-system server through a private network comprises:
sending the cipher text phone number to the front end of the local system, to receive comment information added from the front end of the local system, and send the cipher text phone number to the phone-platform server from the front end of the local system; and
receiving the cipher text phone number returned by the phone platform server through the private network.

17. The computer-readable storage medium of claim 15, wherein the block of obtaining a phone number corresponding to the call instruction, and encrypting the phone number to generate a cipher text phone number comprises:
generating a random number according to the following formula: Xₙ₊₁=(aXₙ+b)modc, wherein the Xₙ₊₁ is the n+1th random number and the Xₙ is the nth random number, a, b, and c are constants and are prime numbers; and
encrypting the obtained phone number using the random number according to a preset operational rule to obtain an encrypted intermediate result; and
obtaining the first clock information that receives the call instruction, and adding the first clock information to the encrypted intermediate result to generate a cipher text phone number.

18. The computer-readable storage medium of claim 17, wherein the block of decrypting the cipher text phone number to obtain a plaintext phone number at local-system server comprises:
when receiving the cipher text phone number returned by the phone-platform server, acquiring the second clock information that receives the cipher text phone number and the first clock information comprised in the cipher text phone number; and
when the first clock information matches the second clock information, decrypting the cipher text phone number to obtain the plain text phone number according to the random number.

19. The computer-readable storage medium of claim 18, wherein the block of when the first clock information matches the second clock information, decrypting the cipher text phone number to obtain the plain text phone number according to the random number comprises:
determining whether a difference between a time value of the second clock information and a time value of the first clock information is within a preset time range; and
when the difference between the time value of the second clock information and the time value of the first clock information is within a preset time range, determining that the first clock information matches the second clock information; and
when the first clock information matches the second clock information match, the cipher text telephone number and the random number are inversely operated using the preset operational rule to decrypt the cipher text telephone number to obtain the plain text telephone number.

20. The computer-readable storage medium of claim 15, further comprising, subsequent to the block of sending the plaintext phone number to the phone-platform server through the private network, the softphone encrypting and decrypting program being executed by the processor to perform the following operation:
transmitting the preset encryption scheme in the local system server to the telephone platform server through the private network, so that the telephone platform server encrypts the call recording corresponding to the plain text telephone number according to the preset encryption scheme.
